(19) United States
(12) Patent Application Publication
(10) Pub. No.: US 2015/0134516 A1
(43) Pub. Date: May 14, 2015

(54) SYSTEM AND METHOD FOR RAISING AND ADMINISTERING A FUND

(71) Applicant: Elizabeth Lankester, Claremont (AU)

(72) Inventor: Matthew Hornibrook, Claremont (AU)

(73) Assignee: Elizabeth Lankester, Claremont, WA (AU)

(21) Appl. No.: 14/398,907

(22) PCT Filed: May 3, 2013
(86) PCT No.: PCT/AU2013/000462

§ 371 Date: Nov. 4, 2014

(30) Foreign Application Priority Data
May 4, 2012 (AU) 2012901828

(51) Int. Cl. G06Q 30/02; G06Q 20/14

(52) U.S. Cl. CPC G06Q 30/0279; G06Q 20/14
USPC 705/40

(57) ABSTRACT

A system for fundraising, the system comprising: an invoicing module operable to generate an invoice, the invoice comprising an amount payable for one or more goods and/or services, and a further amount for a fund; and a payment processing module operable to received payment for the invoice, and to deposit an amount corresponding to the further amount into an account.

### CROSS REFERENCE TO RELATED APPLICATIONS

This application is a 371 U.S. National Stage of International Application No. PCT/AU2013/000462, filed May 3, 2013. This application claims priority to Australian Patent Application No. 2012901828, filed May 4, 2012. The disclosures of the above applications are incorporated herein by reference.

### FIELD

The present invention relates generally to a system and method for fundraising.

Although the present invention will be described with particular reference to a system and method for raising and administering a funding source comprising donations, it will be appreciated that it may be used in respect of other sources of funding.

### BACKGROUND

Funding comprises providing resources, typically in the form of money or financing, for a cause which may be, for example, a project, a person or other legal entity.

A fund is usually created through a fundraising, which comprises soliciting and gathering voluntary contributions of money or other resources. Typically, fundraising refers to efforts to gather money for non-profit organisations or enterprises, but it may also include the solicitation of investors or other sources of capital for for-profit enterprises.

Traditionally, fundraising has consisted of manually requesting donations from people (either in a private or personal capacity or as an authorized representative of a legal entity such as a company, corporation or foundation) in public, i.e “on the street”, or at their homes, or premises of the legal entity. However, systems have been disclosed for sourcing monetary donations to a fund from contributors or donors electronically via Internet websites and via Short Message Service (SMS) messaging. The current focus of such systems is on extracting the maximum donation possible as a single transaction from the individual person or other entity (the business/company/foundation, for example) making the donation.

Generally, manual (traditional) and electronic (Internet) donations do not have dollar limits, however, donations made via SMS are generally limited to AU$5-AU$10 (an allowable maximum amount is usually dependent on the country of the relevant service provider of the SMS service) with the view to limiting any potential fraud.

Recipients of donated funds are almost invariably single cause focused or related cause focused.

Fundraisers also typically incur significant administration and marketing costs in the pursuit of donations that impact on and reduce or ultimately limit the total amount they can use on their cause.

It is against this background that the present invention has been developed.

### SUMMARY

It is an object of the present invention to overcome, or at least ameliorate, one or more of the deficiencies of the prior art mentioned above, or to provide the consumer with a useful or commercial choice.

Other objects and advantages of the present invention will become apparent from the following description, taken in connection with the accompanying drawings, wherein, by way of illustration and example, a preferred embodiment of the present invention is disclosed.

According to a first broad aspect of the present invention, there is provided a system for fundraising, the system comprising:

an invoicing module operable to generate an invoice, the invoice comprising an amount payable for one or more goods and/or services, and a further amount for a fund; and

a payment processing module operable to receive payment for the invoice, and to deposit an amount corresponding to the further amount into an account;

wherein the one or more goods and/or services are unrelated to the fundraising and the fund provides at least a portion of the further amount for the fundraising.

Preferably, the system further comprises an account processing module or means operable to transfer a balance of funds from the account to one or more further accounts.

The further amount may be payable to the fund, and may be of any one or a combination of different funding sources, including a donation or gift, credit, grant, savings, subsidy, or tax, for example.

The further amount may comprise a fixed or prescribed amount of money, and preferably a nominal amount of relevant currency, such as one cent.

The further amount may be: proportional to a number of goods purchased or a usage of the service; and/or proportional to, or a percentage or other factor of, the amount payable for the one or more goods and/or services.

The one or more goods and/or services may comprise a good or service that is provided continuously or ongoingly by a respective goods or service provider.

Preferably, the goods and/or services is a service and the service is is a telecommuncations service, in which case the service provider may comprise a communications service provider or carrier.

Preferably, the account is owned by a fund raiser.

Preferably, the service provider and the fund raiser are separate legal entities.

Preferably, the system is operable to receive a communication from a communications device, the communication comprising information or data regarding or associated with a contributor to the fund. The information or data may comprise: an identification of the contributor; contact details for the contributor; an identification of the fund; an identification of a provider of the one or more goods and/or services; and an authorization to invoice the further amount for the fund. The identification of the fund may comprise a cause of the fund and a regional location of the cause, which may be selectable from a plurality of causes and regional locations.

The invoicing means may be operable to generate the invoice on the basis of the information or data received.

Preferably, the communication is generated via a software application operable on the communications device. In a preferred form, the software application comprises a mobile application or mobile app that may be downloaded to a storage means of the communications device.

The system may comprise sensing means operable to sense receipt of the communication.

Preferably, the system comprises a database and an associated database management module and, upon sensing receipt of the communication, the database management module is operable to populate the database with the information or data of the communication.

Preferably, operations performed by the system occur automatically, without requiring human intervention.

According to a second broad aspect of the present invention, there is provided a method for raising funds, the method comprising:

generating an invoice, the invoice comprising an amount payable for one or more goods and/or services unrelated to the funds, and a further amount for a fund; and

receiving payment for the invoice, and depositing an amount corresponding to the further amount into an account.

According to a third broad aspect of the present invention, there is provided an invoicing module for use in a system according to the first broad aspect of the present invention as hereinbefore described, or a method according to the second broad aspect of the present invention as hereinbefore described.

According to a fourth broad aspect of the present invention, there is provided a payment processing module for use in a system according to the first broad aspect of the present invention as hereinbefore described, or a method according to the second broad aspect of the present invention as hereinbefore described.

According to a fifth broad aspect of the present invention, there is provided a computer-readable storage medium on which is stored instructions that, when executed by a computing means, causes the computing means to perform the method according to the second broad aspect of the present invention as hereinbefore described.

According to a sixth broad aspect of the present invention, there is provided a computing means programmed to carry out the method according to the second broad aspect of the present invention as hereinbefore described.

According to a seventh broad aspect of the present invention, there is provided a data signal including at least one instruction being capable of being received and interpreted by a computing system, wherein the instruction implements the method according to the second broad aspect of the present invention as hereinbefore described.

According to an eighth broad aspect of the present invention, there is provided a system for fundraising, the system comprising a processor means and storage, the storage having a software application stored thereon, whereby the processor means is operable, under control of the software application, to:

generate an invoice, the invoice comprising an amount payable for one or more goods and/or services unrelated to the fundraising, and a further amount for a fund;

receive payment for the invoice; and

deposit an amount corresponding to the further amount into an account.

According to a ninth broad aspect of the present invention, there is provided a computing device comprising a processing module arranged to interact with a database, the database storing data regarding or associated with a contributor to a fund, wherein the module is arranged to retrieve data from the database, generate an invoice for the contributor on the basis of the retrieved data, the invoice comprising an amount payable for one or more goods and/or services unrelated to the fund, and a further amount for a fund; to receive payment for the invoice, and to deposit an amount corresponding to the further amount into an account.

### BRIEF DESCRIPTION OF THE DRAWINGS

In order that the invention may be more fully understood and put into practice, preferred embodiments thereof will now be described with reference to the accompanying drawings, in which:

FIG. 1 depicts a simplified system diagram of an embodiment of a system in accordance with an aspect of the present invention;

FIG. 2 depicts a more detailed system diagram/flow chart depicting flow of data operations of the system;

FIG. 3 is a flow chart depicting flow of subscription/data/payment operations of a business process implemented by the system;

FIG. 4 is a flow chart depicting flow of a user interface of an application process of the system; and

FIGS. 5 to 20 are screen shots depicting a number of user interactive functions provided by the system.

### DETAILED DESCRIPTION

In the drawings, like features have been referenced with like reference numbers.

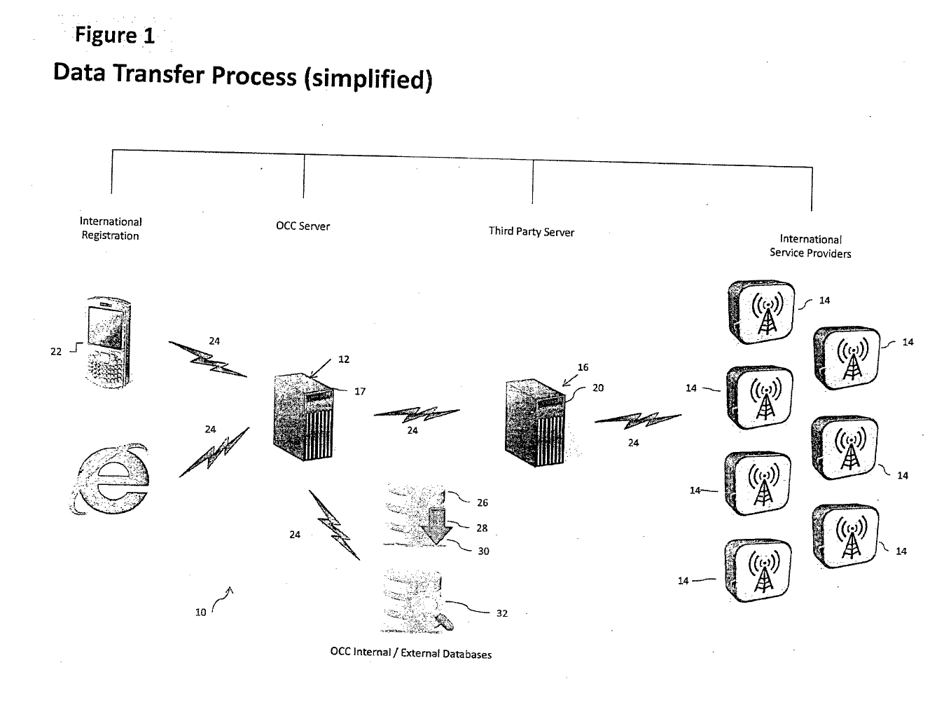

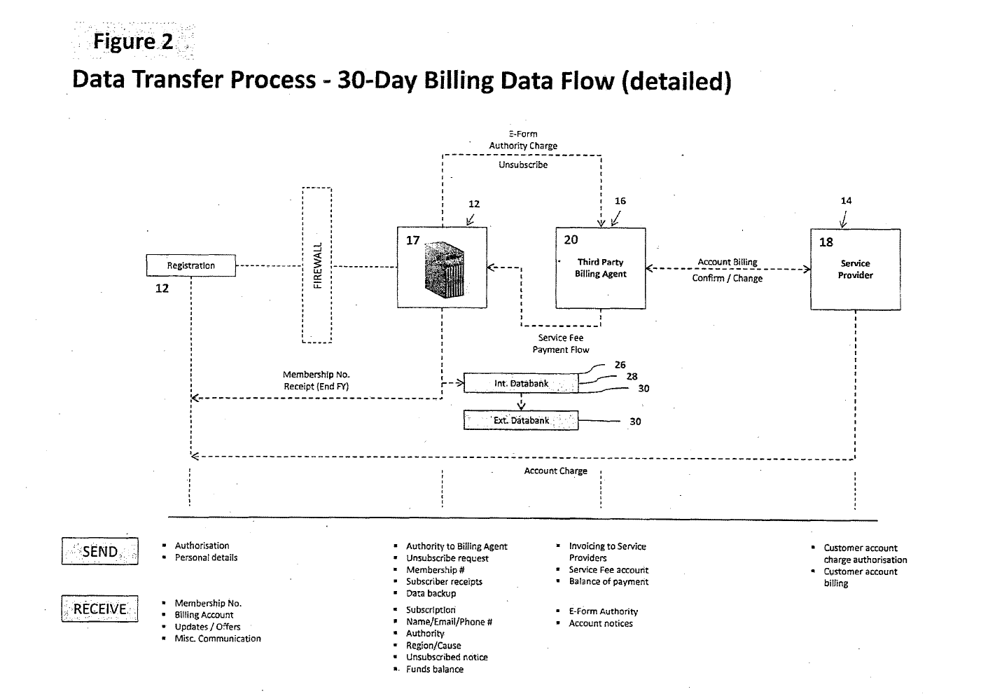

In FIGS. 1 and 2, there is depicted an embodiment of a system 10 for raising and administering a fund in accordance with an aspect of the present invention. The system 10 is provided under the trade mark One Cent Call™ (OCC™) in the embodiment, and is operable to facilitate the raising of funds for distribution or allocation to one or more causes by a fund raiser comprising a One Cent Call™ (OCC™) company.

In the embodiment described, a source of the funding comprises donations of money by persons registered with the fund raiser or subscribed to the system 10 as contributors or donors to the fund. The person may be any entity recognized by applicable laws, including natural persons (i.e. real human beings) and legal or juristic persons such as a company, corporation, or foundation, for example. In embodiments of the invention, the person may be a representative or acting or making the donation on behalf of a non-legal entity, such as a pet. In alternative embodiments of the invention, other sources of funding may be used and the system 10 is not limited in this regard. The funding source may be of any one or a combination of different funding sources, including a donation or gift, credit, grant, savings, subsidy, or tax, for example.

As will be described in further detail, the system 10 comprises an invoicing or billing module, means or application operable to generate one or more invoices to each registered donor. The invoicing module is owned and operated by a provider of goods and/or services. Each invoice comprises an amount payable for one or more goods and/or services, and a further amount for the fund. The system 10 further comprises a payment processing module, means or application, owned and operated by the goods and/or services provider and operable to receive payment or details of payment for each invoice, and to deposit an amount corresponding to the further amount into an account. As will be described in further detail, in the embodiment the amount is payable through a mobile phone account or other telephone or electronic messaging account.

In the embodiment, the account is owned and operated by a third party, legally independent of the fund raiser and the goods and/or services provider. An account processing module, means or application, owned and operated by the third party, is operable to transfer a balance of funds from the account to one or more accounts owned and operated by the fund raiser. In the embodiment described, there are two such accounts, a first or administrative account, into which a first prescribed portion (being approximately 15% in the embodiment) of the funds collected are deposited for use by the fund raiser in meeting its operating and capital expenses, and a second or trust account, into which a second prescribed portion (being the remaining balance or approximately 85% in the embodiment) of the funds collected are deposited for use in supporting one or more causes of the fund. In this way, the fund raiser operates as a “for profit” charity that acts in the interests of both its registered donors or subscribers and shareholders. Depending on the jurisdiction, the fund raiser may be considered a beneficial corporation. Alternative business models may be used in alternative embodiments of the invention.

The proportion of funds distributed amongst the first and second accounts (and any other accounts that the fund raiser may own, operate or be associated with in alternative embodiments of the invention) are not limited to the percentages specified above. In alternative embodiments they may be distributed in any manner desired or required to achieve objectives of the fund raiser. In preferred embodiments of the invention, a maximal or maximum amount possible of the funds received are dedicated to use in supporting the one or more (preferably charitable) causes of the fund.

Having a legally independent third party handling transactions between the fund raiser and the goods and/or services provider is advantageous in facilitating scrutiny or evaluation of the system 10, and particularly the accounting thereof, via auditing and similar actions. Of course, the invention is not limited to having three entities involved and in alternative embodiments all system components could be owned and operated by a single entity, or any number of entities.

It is preferred that more than one cause is supported by the fund and, in the embodiment described, a plurality of causes are supported by the fund. In the embodiment described, the causes relate to or are associated with charitable or social development initiatives domestically and abroad. However, the invention is not limited in this regard, and in alternative embodiments any cause may be supported. Examples of causes that may be supported in embodiments of the invention include: The Fred Hollows Foundation; Save the Children; RSPCA; Habitat for Humanity;and Water for Africa.

During the subscription or registration process, a (registering) donor is able to select which of the plurality of causes they want to be supported by their donation(s), and a region of the cause. In the embodiment, funds in the trust account are distributed or allocated proportionally amongst the causes and regions according to the amount of support each has by the registered donors. They are spent in accordance with the percentage of chosen causes. For example, if 40% of registered donors selected a first cause, 25% of registered donors selected a second cause, and the remaining 35% of donors selected a third cause, then of the funds held in the trust account, 40% would be distributed or allocated to the first cause, 25% would be distributed or allocated to the second cause, and 35% would be distributed or allocated to the third cause. As another example, if 15% of subscribers or registered donors wish to dedicate their donation towards Dafur aid then $15 out of every $100 in the trust account would be used for that purpose.

In alternative embodiments of the invention, the funds are distributed or allocated according to other, or additional, criteria.

The one or more goods and/or services may comprise a good and/or service that is provided on a regular basis or continuously or ongoingly by a goods and/or services provider. In the embodiment described, the service is a telecommuncations service, and the service provider comprises a communications service provider or carrier providing a communications service to the registered donor. Accordingly, in the embodiment, the amount payable for each of the one or more goods and/or services provided in the invoices generated by the communications service provider relate to usage of a communications service provided to the registered donor facilitating use of a communications device. Such services are typically provided on an onging basis, resulting in invoices being generated regularly, according to a billing frequency, period or cycle for the service.

The further amount may comprise a fixed or prescribed amount of money, and preferably a nominal amount of relevant currency, and may be proportional to a number of goods purchased or a usage of the service. In the embodiment described, the further amount comprises one cent (AU$0.01) per particular usage being a telephone call or SMS message made by the registered donor using the communications device. It should be appreciated that the invention is not limited in this regard, and in alternative embodiments the further amount may comprise other amounts, or may be proportional to, or a percentage or other factor of, the amount payable for the one or more goods and/or usage of the services, for example.

Preferably, the third party has one or more agreements or relationships with a plurality of goods and/or services providers, and, during the registration process, a (registering) donor is able to select which of the plurality of goods and/or services providers they use.

In the embodiment, the third party has agreements with a plurality of communications service providers. Particularly, the third party has a Service Charge Agreement or General Billing Agreement in place with a majority of communications service providers internationally—hundreds of major providers worldwide. This global Service Charge Agreement or General Billing Agreement advantageously removes the requirement for individual contracts with each service provider in each market. During the registration process a (registering) donor is able to select which of the plurality of communications service providers they use.

The system 10 comprises a plurality of subsystems or modules operably coupled to enable the system 10 to perform the functions and operations herein described. Particularly, the system 10 comprises a first subsystem 12 owned and operated by the fund raiser, a plurality of second subsystems 14 each owned and operated by a respective one of the communications service providers party to the Service Charge Agreement or General Billing Agreement, and a third subsystem 16 owned and operated by the third party.

Each of the first, second and third subsystems 12, 14 and 16 comprise respective computing systems, which in the embodiment have the form of respective first, second, and third servers 17, 18, and 20. The servers 17, 18 and 20 may be used to execute application and/or system services such as a system and method for fund raising in accordance with an embodiment of the present invention.

Each server 17, 18 and 20 comprises suitable components necessary to receive, store and execute appropriate computer instructions. The components include processing means in the form of a processor, storage means, device or medium in the form of read only memory (ROM) and random access memory (RAM), one or more input/output devices such as disc drives, a user interface (associated with a respective server). Remote communications devices 22 (such as smartphones) are arranged to communicate with the first, second, and third servers 16, 18 and 20 via one or more communications link(s) 24.

Each server 17, 18 and 20 is capable of receiving instructions that may be held in ROM, RAM or disc drives and may be executed by the processor. The processor is operable to perform actions under control of software, as will be described in further detail below, including processing/executing instructions and managing the flow of data and information through each computing system. There may be provided a plurality of communication links 24 which may variously connect to one or more remote devices 22 such as servers, personal computers, terminals, wireless or handheld computing devices, landline communication devices, or mobile communication devices such as a mobile (cell) telephone. At least one of a plurality of communications links 24 may be connected to an external computing network through a telecommunications network.

The first server 17 includes a first operating system which is capable of issuing commands to access a plurality of databases or databanks which reside on the storage device thereof. In the embodiment, three such databases or databanks are provided, comprising: one of subscribers or registered donors, which may be referred to as a subscriber or donor database 26; one of domestic and international causes, which may be referred to as a “Location and Cause” database 28; and one of domestic and international service providers, which may be referred to as a “Service Provider” database 30 The operating system is arranged to interact with the databases 26, 28 and 30 and with one or more computer programs of a first software set or suite to cause the first server 17 to carry out the respective steps, functions and/or procedures in accordance with the embodiment of the invention described herein.

Each of the plurality of second servers 18 includes a respective second operating system which is arranged to interact with one or more computer programs of a second software set or suite to cause the second server 18 to carry out the respective steps, functions and/or procedures in accordance with the embodiment of the invention described herein.

The third server 20 includes a third operating system which is arranged to interact with one or more computer programs of a third software set or suite to cause the third server 20 to carry out the respective steps, functions and/or procedures in accordance with the embodiment of the invention described herein.

Software, or any set of instructions or programs for the computing systems, can be written in any suitable language, as are well known to persons skilled in the art. Furthermore, the software may comprise a set of software and can be provided as stand-alone application(s), via a network, or added as middleware, depending on the system requirements.

In alternative embodiments of the invention, the software may comprise one or more modules, and may be implemented in hardware. In such a case, for example, the modules may be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA) and the like.

The computing systems can be of any suitable type, including: a programmable logic controller (PLC); digital signal processor (DSP); microcontroller; personal, notebook or tablet computer, or dedicated servers (as in the embodiment described) or networked servers.

The processors can be any custom made or commercially available processor, a central processing unit (CPU), a data signal processor (DSP) or an auxiliary processor among several processors associated with the computing means. In embodiments of the invention, the processing means may be a semiconductor based microprocessor (in the form of a microchip) or a macroprocessor, for example.

It will be understood that the database may reside on any suitable storage device, which may encompass solid state drives, hard disc drives, optical drives or magnetic tape drives. The database may reside on a single physical storage device or may be spread across multiple storage devices.

In embodiments of the invention, the storage means, device or medium can include any one or combination of volatile memory elements (e.g., random access memory (RAM) such as dynamic random access memory (DRAM), static random access memory (SRAM)) and non-volatile memory elements (e.g., read only memory (ROM), erasable programmable read only memory (EPROM), electronically erasable programmable read only memory (EEPROM), programmable read only memory (PROM), tape, compact disc read only memory (CD-ROM), etc.). The storage medium may incorporate electronic, magnetic, optical and/or other types of storage media. Furthermore, the storage medium can have a distributed architecture, where various components are situated remote from one another, but can be accessed by the processing means. For example, the ROM may store various instructions, programs, software, or applications to be executed by the processing means to control the operation of the reader and the RAM may temporarily store variables or results of the operations.

The use and operation of computers using software applications is well-known to persons skilled in the art and need not be described in any further detail herein except as is relevant to the present invention.

Furthermore, any suitable communication protocol can be used to facilitate communication between any subsystems or components of the system 10, and the system 10 and other devices, including wired and wireless, as are well known to persons skilled in the art and need not be described in any further detail herein except as is relevant to the present invention.

Where the words “store”, “hold” and “save” or similar words are used in the context of the present invention, they are to be understood as including reference to the retaining or holding of data or information both permanently and/or temporarily in the storage means, device or medium for later retrieval, and momentarily or instantaneously, for example as part of a processing operation being performed.

Additionally, where the terms “system” and “device” are used in the context of the present invention, they are to be understood as including reference to any group of functionally related or interacting, interrelated, interdependent or associated components or elements that may be located in proximity to, separate from, integrated with, or discrete from, each other.

Furthermore, in embodiments of the invention, the word “determining” is understood to include receiving or accessing the relevant data or information.

In the embodiment described, the first software set comprises: a web server application or module, a registration application or module, an administration application or module, and an email application or module.

The web server application is operable to deliver content relating to the system 10 via a dedicated website, such as web pages or other electronic pages or screens, to existing or potential participants in the system 10, such as a donor to the fund. The website is accessible via a web browser of an Internet enabled mobile communication device, such as a notebook computer or a smartphone, operably connected to be in data communication with the system 10 via a communication network. In the embodiment described, the means of data communication is through the Internet, however, other methods, such as direct connection, may be employed in other embodiments of the invention.

The content may include advertising and promotional or public relations information delivered via an appropriate one or combination of forums or medium including, for example, YouTube, Facebook or Twitter. In embodiments of the invention, the content may comprise where and how donor contributions are being used.

The device may be any device capable of communicating with the system 10, including a personal, notebook or tablet computer such as that marketed under the trade mark IPAD® or IPOD TOUCH®by Apple Inc,or by other provider such as Hewlett-Packard Company, or Dell, Inc, for example,or a smartphone such as that marketed under the trade mark IPHONE® by Apple Inc, or by other provider such as Nokia Corporation, or Samsung Group, having Android, WEBOS, Windows, or other Phone app platform.

One of the web pages that may be accessed comprises an online registration page. The web server application is operable to enable a potential donor to manually register or record themselves as a donor by completing and submitting to the first server 17, via the registration page, a communication in the form of an electronic registration form comprising donor registration information. The donor registration information includes details or data relating to the donor including their name(s) and any other relevant identification (such as an Australian Company Number (ACN) in the case of an Australian company, for example), contact information including their, email address, country they are located in, Service Provider and a number of the donor's smartphone, identification of at least one region and cause to which their donation(s) are to be contributed, and an authority to invoice the amount to be donated. In alternative embodiments of the invention, the donor registration information may comprise alternative or additional details or data.

Each of the databases 26, 28, and 30 are coupled to the first server 17 and are in data communication therewith in order to enable data to be read to and from the databases 26, 28, and 30 as is well known to persons skilled in the art. Any suitable database structure can be used. Any one or all of the databases 26, 28, and 30 can be provided locally as a component of the first server 17 (such as in the memory device) or remotely such as on a remote server, as can the first set of software. In an embodiment, several computers can be set up in this way to have a network client-server application. In the embodiment described each of the databases 26, 28 and 30 is stored internally in the memory device of the first server 17 as partitions of a single database structure. Furthermore, a copy of the data stored in each of the databases 26, 28 and 30 is stored in an external memory device remote 32 from the first server 17, and updated periodically to provide for backup storage of the data. In alternative embodiments of the invention, there may be more or less than three databases.

The subscriber or donor database 26 has a plurality of donor records. Each donor record comprises a set of donor information relating to a registered donor of the system 10 including the donor registration information as hereinbefore described, along with other information associated with the registered donor, including a membership number allocated to the donor by the first server 10, and a total amount donated by the donor. Particularly, the information recorded includes: Name; Email; Phone Number; Region of Interest; Cause; Location (Country only); Service Provider; membership number; total amount donated; and Authorisation of subscriber Terms and Conditions (T&C's).

The first server 17 has sensing means operable to sense or detect the receipt of communications comprising donor registration information (sent via the dedicated website or other means as herein described). Upon sensing the receipt of such information, the first server 17, via its processor under control of relevant applications of the first software set, including a database management module or application, is operable to generate, populate and manage donor records in the database 26, (as well as records in the other databases 28 and 30) and to execute actions as described herein according to the data and information received and processed or transformed from one (or a first) state to another (or second) state by the first server 17.

The registration application provides an alternative means via which a potential donor can automatically register or record themselves as a donor. The registration application or “app” can be downloaded or otherwised saved to the device by the potential donor. Once installed on the device the registration application is operable to present, via an interface such as a touchscreen of the device, a sequence of electronic pages, screens and forms to the donor allowing for the inputting or capture of the donor registration information. Completion of these by the donor, via the interface, results in the inputted donor registration information being communicated to the first server 17 for populating in relevant fields of the database 26. Particularly, via the registration app the donor is able to interact with the system 10 and perform actions including inputting data or information required to register therewith.

In an embodiment of the invention, the system 10 is operable to automatically allocate a membership number to the donor upon purchase, download or installation of the app. In such an embodiment the system may be operable to communicate the allocated membership number to the device of the donor when the app is downloaded, to create a corresponding donor record in the database, and record in the record any relevant information or data that can be captured by action of the purchase, download or installation. This is an advantageous process enabling automatic capture of information and data regarding persons who (by purchasing, downloading or installing the app) have at least expressed an interest in contributing. In embodiments of the invention, additional and/or alternative operations performed by the system 10 occur automatically, without requiring human intervention.

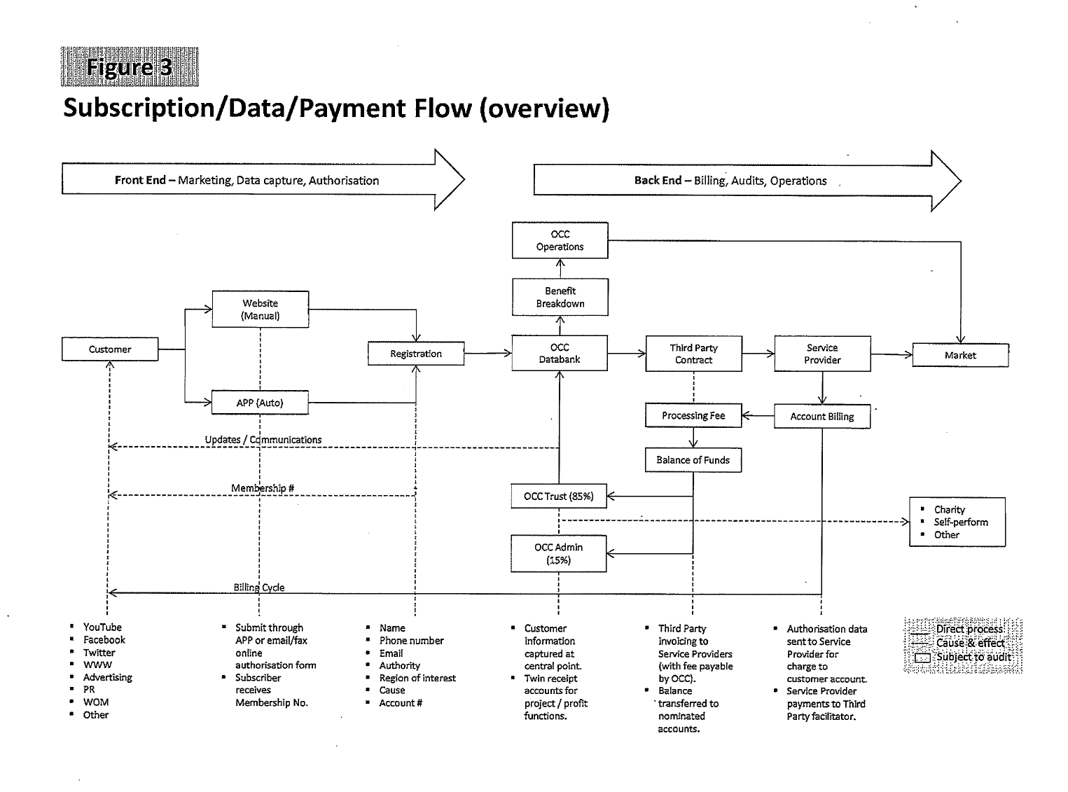

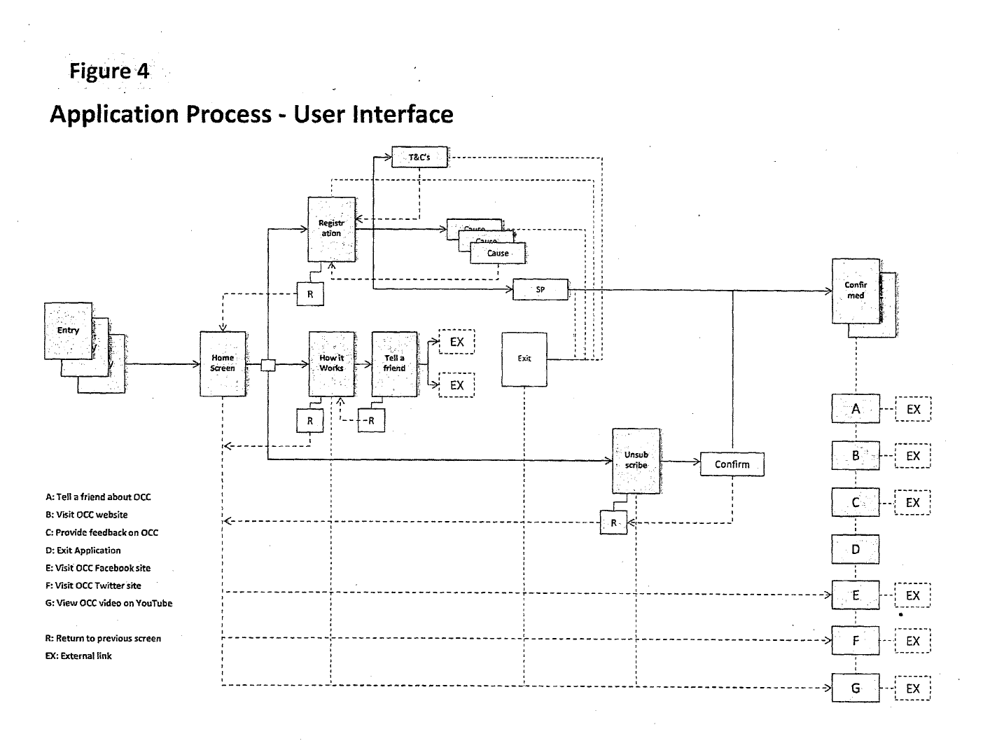

FIG. 4 depicts a flow chart depicting flow of the sequence of electronic pages provided during execution of the registration application via the user interface to implement the donor registration process.

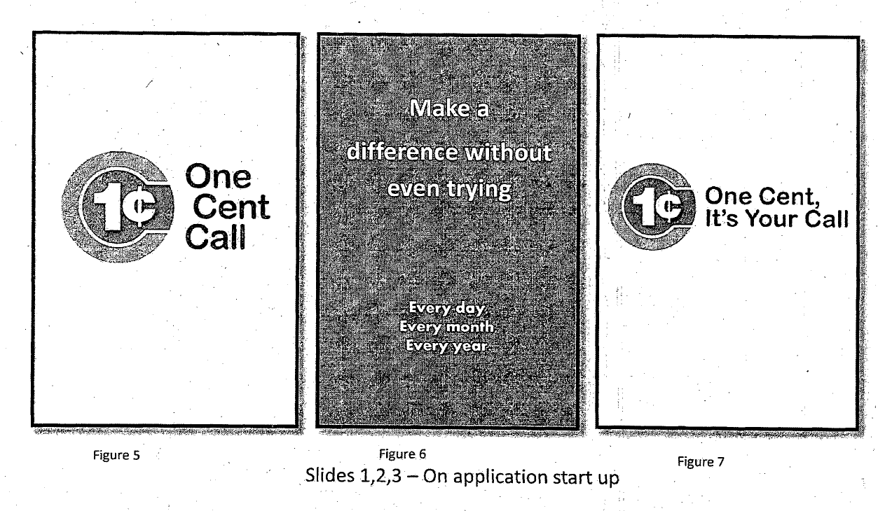

FIGS. 5, 6 and 7 show examples of screens displayed via the interface on initial start up or execution of the registration application. It is to be appreciated that these, and the other screens illustrated herein, are examples of screen shots of the embodiment. In embodiments of the invention, these may be altered to suit subscriber demand or user feedback or to improve functionality, for example, and so other screens having a difference visual appearance are possible.

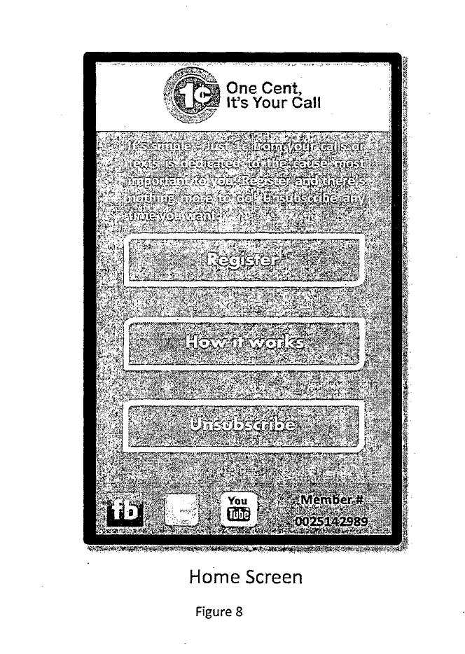

An example of a “Home” screen is depicted in FIG. 8 of the drawings. Interface elements in the form of buttons are provided on the Home Screen allowing the donor to: chose to register to donate (via execution of a “Registration” button); review information describing operation of the system 10 (via execution of an “How It Works” button); and unsubscribe as a donor (via execution of an “Unsubscribe” button).

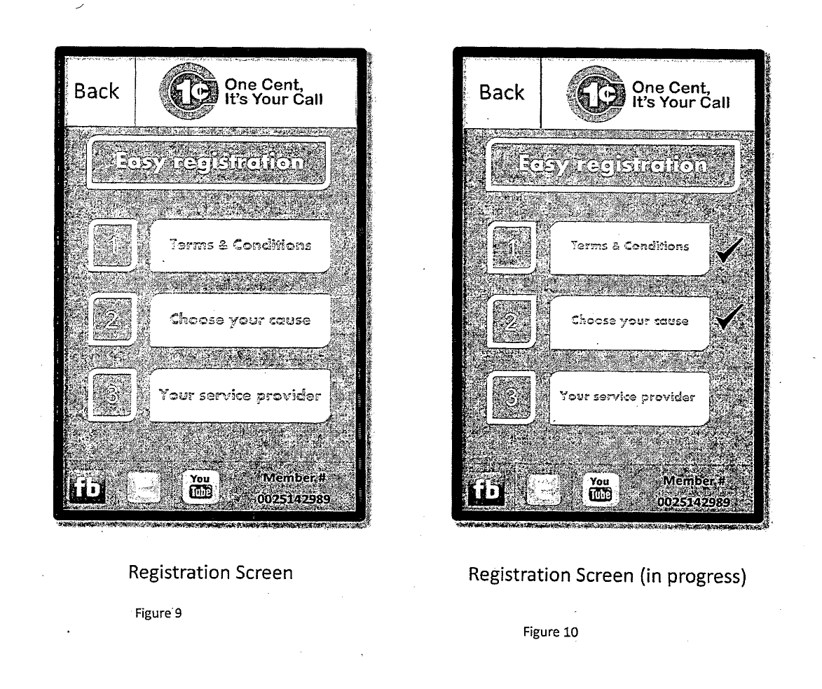

Execution of the Registration button leads to a “Registration” screen, an example of which is depicted in FIG. 9, being displayed via the interface and enabling the donor to submit the donor registration information. This is achieved via a three step, easy registration process that must be completed. Each step in the registration process is represented by a corresponding interface element button provided on the Registration screen and undertaken by the donor executing the corresponding interface element button. Once each step is completed, the application is operable to return the donor to the Registration screen, updated to indicate that the step has been successfully completed. The indication may be provided by a suitable visual representation, such as, for example, a graphic “tick” next to, or fading, the button corresponding to the completed step. FIG. 10 of the drawings shows an example of a Registration screen “in progress” in this regard.

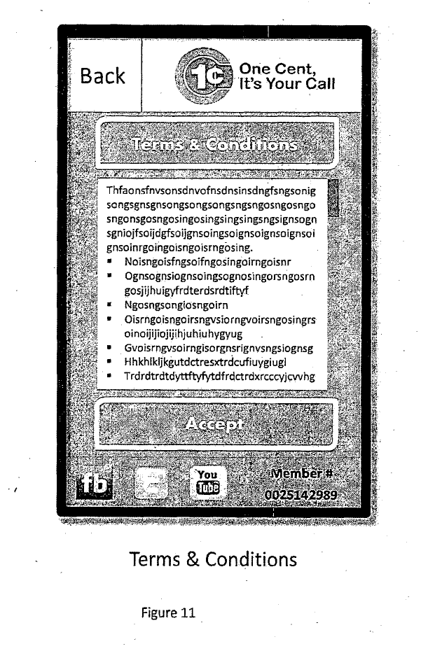

The first step is that the donor must accept terms and conditions (T&C's).governing use of the system 10 to make donations. This is done by the user executing a “Terms and Conditions” button provided on the Registration screen. Execution of that button results in a “Terms and Conditions” screen being displayed, an example of which is depicted in FIG. 11. The Terms and Conditions screen displays the terms and conditions which the donor must agree to abide by in order to use (i.e. make donations via) the system, along with an interface element “Accept” button by the execution of which the donor indicates their understanding and agreement to abide by the terms and conditions.

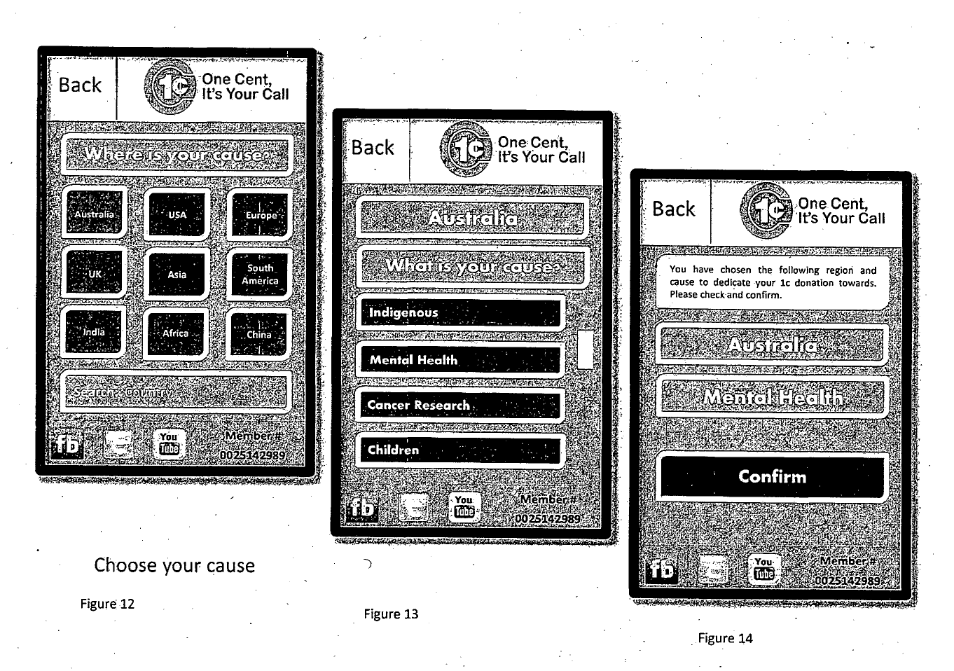

The second step is that the donor must choose the cause they wish to support by their donations. This is done by the user executing a “Choose your cause” button provided on the Registration screen. Execution of that button results in a “Where is your cause” screen being displayed, an example of which is depicted in FIG. 12. The Where is your cause screen displays a searchable and selectable list of countries having causes supported by the funds raised via the system 10, details of which are stored in the Location and Cause database 28. Once the donor has selected the country, the registration application is operable to display a “What is your cause” screen, an example of which is depicted in FIG. 13. The What is your cause screen displays a searchable and selectable list of causes (in the selected country) supported by the funds raised via the system 10. Once the donor has selected the cause, the registration application is operable to display a Confirmation screen showing the selected country and cause to which their donations are to be dedicated towards, along with an interface element “Confirm” button by the execution of which the donor indicates their confirmation that the selected country and cause is correct. FIG. 14 of the drawings shows an example of the Confirmation screen.

Allowing the (registering) donor to choose their cause via the Location and Cause database 28 advantageously gives control of spending of the funds raised to the subscriber or donor. In this way a platform is established that can connect/unify every subscribing person to a particular or single cause or project.

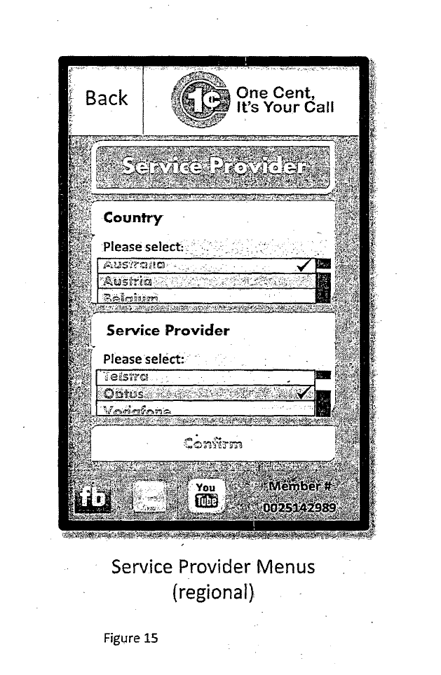

The third step is that the donor must choose their service provider. This is done by the user executing a “Your service provider” button provided on the Registration screen. Execution of that button results in a “Service Provider” screen being displayed, an example of which is depicted in FIG. 15. The Service Provider screen displays searchable and selectable lists of countries and service providers operating therein, details of which are stored in the Service Provider database 30. Once the donor has selected the relevant country and service provider, they indicate their confirmation thereof by execution of a “Confirm” button provided on the Service Provider screen.

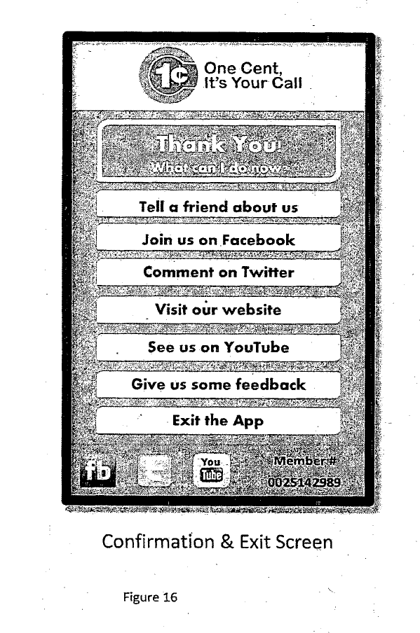

On successful completion of the third step, the inputted information is communicated to the first server 17 for population in the database 26 as hereinbefore described. The membership number allocated to the donor upon successful registration is communicated to the device, and displayed in a “Member #” portion of the interface. A “Confirmation and Exit” screen, an example of which is shown in FIG. 16, is generated and displayed via the interface. The Confirmation and Exit screen thanks the donor, and provides them with a list of optional actions, each implemented by execution of a corresponding interface element button.ln the embodiment described, the optional actions include: telling a friend about the One Cent Call™ system 10; joining the One Cent Call™ system on Facebook; commenting on the One Cent Call™ system 10 on Twitter; visiting the One Cent Call™ system 10 website; viewing One Cent Call™ system 10 material on YouTube; providing feedback on the One Cent Call™ system 10; and exiting the registration application. These optional actions involving social networking and media services encourage the development of a formalised community of registered donors or subscribers through an interactive social network.

Details of the successful registration of the donor (including the allocated membership number) are also communicated from the first server 17 to the applicable one of the plurality of second servers 18 and the third server 20 in an authorisation communication message confirming the registration of the donor and that future invoices generated for services provided to them by the selected communications service provider are to include the further amount (to be donated to the fund) as hereinbefore described. Each of the plurality of second servers 18 and the third server 20 have sensing means operable to sense or detect the receipt of such communications and to update their operations accordingly.

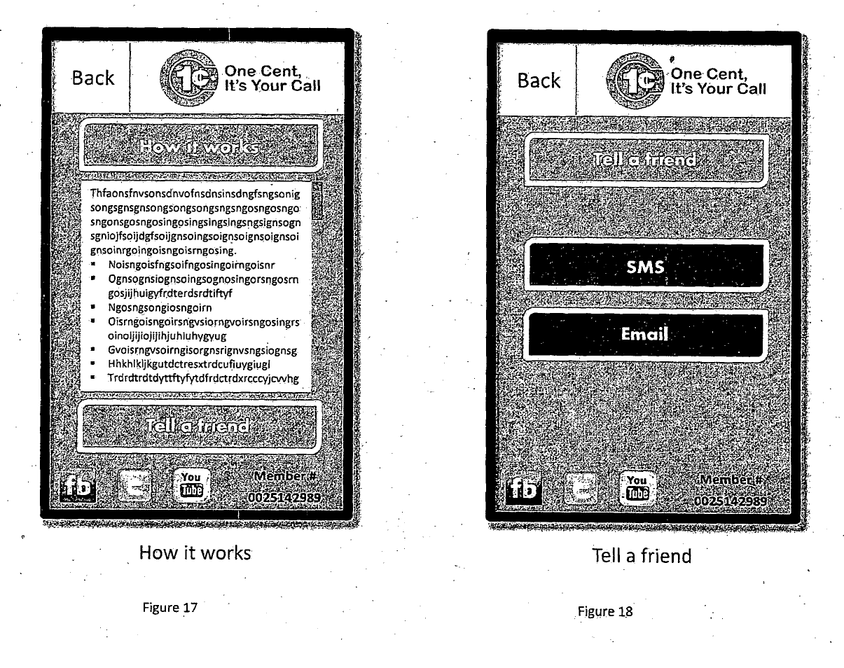

Execution of the How it works button leads to a “How it works” screen, an example of which is depicted in FIG. 17, being displayed via the interface. The how it works screen displays information describing and explaining operation of the system 10. An interface element “Tell a friend” button is provided on the How it works screen, the execution of which leads to the generation and display of a “Tell a friend” screen. FIG. 18 shows an example of a Tell a friend screen providing options to the donor to inform another party of the system 10 via email or short message service (SMS) communication, each option being implemented by execution of a corresponding interface element button.

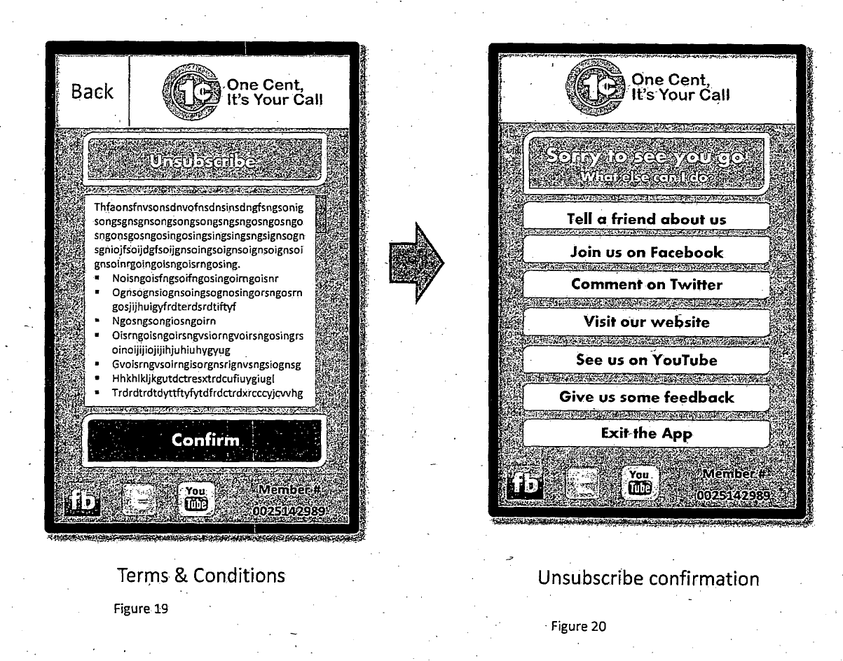

Execution of the Unsubscribe button leads to an “Unsubscribe” screen, an example of which is depicted in FIG. 19, being displayed via the interface. The Unsubscribe screen displays the terms and conditions which the donor must agree to abide by in order to discontinue their use of the system 10, along with an interface element “Confirm” button by the execution of which the donor indicates their understanding and agreement to abide by the terms and conditions. Upon such confirmation, An “Unsubscribe confirmation” screen, an example of which is shown in FIG. 20, is generated and displayed via the interface. The Unscribscribe confirmation screen expresses sorrow at the unsubscription of the donor, and provides them with a list of optional actions, each implemented by execution of a corresponding interface element button.In the embodiment described, the optional actions are the same as those provided on the “Confirmation and Exit” screen as hereinbefore described.

Allowing registration via an instant, downloadable application, or via the website, is advantageous as it provides for a “donate and forget” platform for the average person to get engaged with something positive (i.e. a cause of their selection) with little and no ongoing effort.

The administration application is operable to facilitate the performance of business administration and management functions associated with the One Cent Call™ (OCC™) company. This incudes managing the administration and trust accounts. Additionally, the administration application or module includes analysis and reporting applications or modules. These are respectively operable to analyse or process data and information pertinent to the system 10, such as the amount of funds contributed by each donor, and a “benefit breakdown” comprising where and how the contributions are being or have been used, and to generate reports on the results of the analysis. Depending on the information contained in the reports, they may be made publicly available, such as via the dedicated website, and/or privately, such as, via an optionally encrypted communication to the communications device 22, for example. Depending on its content, the report may be used by the donor for accounting purposes, such as preparing a tax return allowing for claiming of donations or contributions as a tax deduction.

The email application is operable to enable email message communication between the first server 17 and devices in communication therewith.

A potential donor can also register or record themselves as a donor by providing the donor registration information to the fund raiser via email, facsimile, or other communication for automatic capture and entry into the database by action of software of the first set of software or by a data entry operator or other employee of the fund raiser.

Referring now to the second server 18, in the embodiment described, the second software set comprises: the invoicing or billing module and the payment processing module.

As described previously, the invoicing module is operable to generate an invoice for each subscriber or registered donor comprising an amount payable according to their usage of communications services over the invoicing period, and a further amount for the fund (calculated as hereinbefore described).

As described previously, the payment processing module is operable to receive payment for each invoice, and to transfer an amount corresponding to the further amount to the account of the third party.

Referring now to the third server 20, the third software set comprises the account processing module

As described previously, the account processing module is operable to transfer a balance of funds from the account to the administrative and trust accounts of the fund raiser.

The above and other features and advantages of the embodiment of the invention will now be further described with reference to the system 10 in use.

An interested person subscribes to or registers as a donor of the system 10 via the registration process as hereinbefore described.

Once registered, the donor uses their communications device 22 as per usual in accordance with the service provided to them by the respective communications service provider.

Usage of the communications device 22 is recorded by the service provider for the invoicing period and used by the invoicing module of the second server 18 in generating the invoice at the end of the invoicing period.

When the invoice is paid, via action of the payment processing module of the second server , the amount payable according to the donors usage of communications services over the invoicing period is retained by the communications service provider. The further amount is transferred to the account of the third party.

Subsequently, the funds are transferred from the account to the administrative and trust accounts of the fund raiser via action of the account processing module.

From there, the funds in the trust account are allocated to the chosen cause as hereinbefore described via action of the administration application.

It will be appreciated that the embodiment of the invention simplifies the donation process for a mass market using a low payment (i.e. 1 cent) across a wide market. It provides an electronic mechanism (the registration application supported by other electronic media and components of the system 10) that allows members of a potentially international market (anyone with a communications device) to perpetually donate to a central administration point or administrator (being the fund raiser). Furthermore, it enables them to do this without using cash, credit cards or any other system of payment other than their account with their communications service provider (i.e. their telephone account). It is a low cost operation that does not impact on donors time and requires no input or action from them following successful registration. Registered donors or subscribers control what their contribution is, i.e. how much they donate, through the number of telephone calls or SMS messages made through their account during their billing cycle. They also control how their donation is used, through selection of a regional cause, and can thereby dedicate their donations to a specific cause or area (market) of need or which appeals to them.

The embodiment of the invention provides additional fund raising capability to all causes such as charities connected or associated with the fund raiser, reducing the amount they require raising and reducing their costs associated with fundraising.

The embodiment of the invention provides a low cost, non-invasive platform for a global community of donors to collectively contribute funds to causes including social development initiatives both domestically and abroad. The embodiment allows for the community of donors to be formalized through an interactive social network.

It can be seen that the embodiment of the invention provides a recurring phone debit charge product, applied internationally, and dedicated to community benefit. It allows subscribers or donors to nominate the region and cause they have the greatest interest in and monitor development programs therein. Although payments are recurring (dependent on individual billing cycles), the subscriber or donor controls the amount paid through their communications device usage.

Advantageously, the embodiment of the invention provides a platform for subscribers to register and move on. Account maintenance from subscribers is not required, unless unsubscribing. Additionally, it does not involve any ongoing monetary management on behalf of subscribers. Simple selection of a regional cause for their money to go to provides for simple involvement or “buy in” from each subscriber.

It will be appreciated by those skilled in the art that variations and modifications to the invention described herein will be apparent without departing from the spirit and scope thereof. The variations and modifications as would be apparent to persons skilled in the art are deemed to fall within the broad scope and ambit of the invention as herein set forth.

Throughout the specification and claims, unless the context requires otherwise, the word “comprise” or variations such as “comprises” or “comprising”, will be understood to imply the inclusion of a stated integer or group of integers but not the exclusion of any other integer or group of integers.

Throughout the specification and claims, unless the context requires otherwise, the term “substantially” or “about” will be understood to not be limited to the value for the range qualified by the terms.

It will be clearly understood that, if a prior art publication is referred to herein, that reference does not constitute an admission that the publication forms part of the common general knowledge in the art in Australia or in any other country.

1. A system for fundraising, the system comprising:
an invoicing module operable to generate an invoice, the invoice comprising an amount payable for one or more goods and/or services, and a further amount for a fund; and
a payment processing module operable to receive payment for the invoice, and to deposit an amount corresponding to the further amount into an account
wherein the one or more goods and/or services are unrelated to the fundraising and the fund provides at least a portion of the further amount for the fundraising.

2. A system for fundraising, the system comprising a processor means and a storage means, the storage means having a software application stored thereon, whereby the processor means is operable, under control of the software application, to:
generate an invoice, the invoice comprising an amount payable for one or more goods and/or services that are unrelated to the fundraising, and a further amount for a fund; and
receive payment for the invoice, and to deposit an amount corresponding to the further amount into an account.

3. The system of claim 1, comprising an account processing module operable to transfer a balance of funds from the account to one or more further accounts.

4. The system of claim 1, wherein the further amount: is payable to the fund; is any one or a combination of different funding sources, including a donation or gift, credit, grant, savings, subsidy, or tax; comprises a fixed or prescribed amount of money;
comprises a nominal amount of relevant currency; is proportional to a number of goods purchased or a usage of the service; and/or is proportional to, or a percentage or other factor of, the amount payable for the one or more goods and/or services.

5. The system of claim 1, wherein the one or more goods and/or services comprises a good or service that is provided continuously or ongoingly by a respect goods or service provider.

6. The system of claim 1, wherein the goods and/or services are a service, and the service is a telecommuncations service and the service provider comprises a communications service provider or carrier.

7. The system of claim 1, wherein the system is operable to receive a communication from a communications device, the communication comprising information or data regarding or associated with a contributor to the fund.

8. The system of claim 7, wherein the information or data comprises one or more of: an identification of the contributor; contact details for the contributor; an identification of the fund; an identification of a provider of the one or more goods and/or services; and an authorization to invoice the further amount for the fund.

9. The system of claim 8, wherein the identification of the fund comprises a cause of the fund and a regional location of the cause, selectable from a plurality of causes and regional locations.

10. The system of claim 7, wherein the invoicing means is operable to generate the invoice on the basis of the information or data received.

11. The system of claim 7, wherein the communication is generated via a software application operable on the communications device.

12. The system of claim 11, wherein the software application comprises a mobile application or mobile app downloadable to a storage means of the communications device.

13. The system of claim 7, comprising sensing means operable to sense receipt of the communication.

14. The system of claim 13, comprising a database and an associated database management module, wherein upon sensing receipt of the communication, the database management module is operable to populate the database with the information or data of the communication.

15. The system of claim 1, wherein operations performed by the system occur automatically, without requiring human intervention.

16. A method for raising funds, the method comprising:
generating an invoice, the invoice comprising an amount payable for one or more goods and/or services unrelated to the funds, and a further amount for a fund; and
receiving payment for the invoice, and depositing an amount corresponding to the further amount into an account.

17. An invoicing module for use in the system of claim 1.

18. A payment processing module for use in the system of claim 1.

19. A computer-readable storage medium on which is stored instructions that, when executed by a computing means, causes the computing means to perform the method according to claim 16.

20. A computing means programmed to carry out the method according to claim 16.

21. A data signal including at least one instruction being capable of being received and interpreted by a computing system, wherein the instruction implements the method according to claim 16.

22. A system for fundraising, the system comprising a processor means and storage, the storage having a software application stored thereon, whereby the processor means is operable, under control of the software application, to:
generate an invoice, the invoice comprising an amount payable for one or more goods and/or services unrelated to the fundraising, and a further amount for a fund;
receive payment for the invoice; and
deposit an amount corresponding to the further amount into an account.

23. A computing device comprising a processing module arranged to interact with a database, the database storing data regarding or associated with a contributor to a fund, wherein the module is arranged to retrieve data from the database, generate an invoice for the contributor on the basis of the retrieved data, the invoice comprising an amount payable for one or more goods and/or services unrelated to the fund, and a further amount for the fund; to receive payment for the invoice, and to deposit an amount corresponding to the further amount into an account.

24. An invoicing module for use in the method of claim 16.

25. A payment processing module for use in the method of claim 16.
